(19) United States
(12) Patent Application Publication
(10) Pub. No.: US 2022/0035442 A1
(43) Pub. Date: Feb. 3, 2022

(54) MOVIE DISTRIBUTION METHOD

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/008,268

(22) Filed: Aug. 31, 2020

(30) Foreign Application Priority Data
Jul. 29, 2020 (JP) 2020-128306

(51) Int. Cl. G06F 3/01; G06T 13/80; H04N 21/854; H04N 21/81

(52) U.S. Cl. CPC G06F 3/011; H04N 21/816; H04N 21/854; G06T 13/80

(57) ABSTRACT

To enable you to take animations in a virtual space, a method for distributing video, the method comprising: placing a character in a virtual space; detecting an input of a user from at least one of a head mounted display and a controller which the user mounted; controlling an action of the character in response to the input; controlling a virtual camera placed in the virtual space in response to the input; and distributing movie data shot by the camera.

### TECHNICAL FIELD

The present invention relates to a method of video distribution.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem is a method of distributing a video, wherein a character is disposed in a virtual space, an input of the user is detected from at least one of a head mount display and a controller mounted by a user, the operation of the character is controlled in response to the input, a virtual camera disposed in the virtual space is controlled in response to the input, and video data captured by the camera is distributed.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in the video distribution system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating a functional configuration of an image producing device 310 according to the present embodiment;

FIG. 8 is a diagram illustrating a flow of a video distribution process according to a movie distribution system according to the present embodiment;

### DESCRIPTION OF EMBODIMENTS

The contents of embodiments of the present invention will be described with reference. The present invention includes, for example, the following configurations.

### Item 1

A method for distributing video, the method comprising:

placing a character in a virtual space;

detecting an input of a user from at least one of a head mounted display and a controller which the user mounted;

controlling an action of the character in response to the input;

controlling a virtual camera placed in the virtual space in response to the input; and

distributing movie data shot by the camera.

### Item 2

The method for distributing video according to item 1, the method further comprising

at least once a day, placing the character, detecting the input, controlling the action of the character in response to the input, controlling the camera in response to the input, and distributing the movie data.

### Item 3

The method for distributing video according to item 1, the method further comprising

recording action data representing the action of the character controlled in response to the input; and

distributing the movie data captured by controlling the camera while playing the action of the character based on the action data.

A specific example of the video distribution system 300 according to one embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

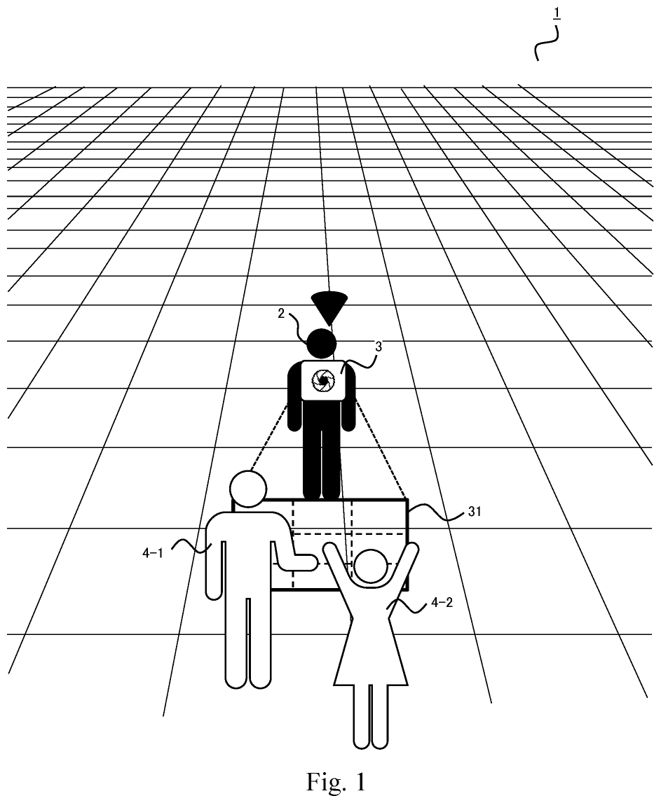

FIG. 1 is a diagram illustrating an example of a virtual space displayed on a head mount display (HMD) mounted by a user in the video distribution system 300 of the present embodiment. In the video distribution system 300 of the present embodiment, a virtual character 4 and a virtual camera 3 are disposed in the virtual space 1, and a camera 3 is used to shoot a character 4. In the virtual space 1, a photographer 2 (a photographer character) is disposed, and the camera 3 is virtually operated by the photographer 2. In the video distribution system 300 of this embodiment, as shown in FIG. 1, a user makes an animation by arranging a character 4 and a camera 3 while viewing the virtual space 1 from a bird's perspective using a TPV (Third Person's View), shooting a character 4 using an FPV (First Person View), or performing a character 4 using an FPV (First Person's View). In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). In other words, in the video distribution system 300 of the present embodiment, one can play a number of roles (roles). In addition, since the camera 2 can be virtually operated as the photographer 2, natural camera work can be realized and the representation of the movie to be shot can be enriched.

### General Configuration

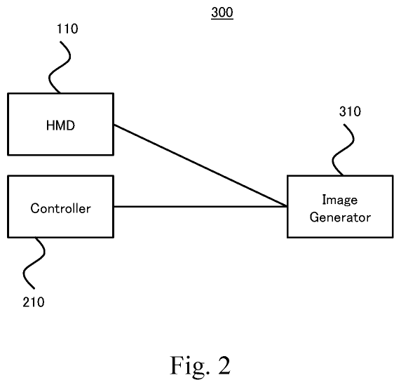

FIG. 2 is a diagram illustrating an example of the overall configuration of the video distribution system 300 according to an embodiment of the present invention. The video distribution system 300 may comprise, for example, an HMD 110, a controller 210, and an image generating device 310 that functions as a host computer. An infrared camera (not shown) for detecting the position, orientation and slope of the HMD 110 or the controller 210 can also be added to the video distribution system 300. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### HMD 110

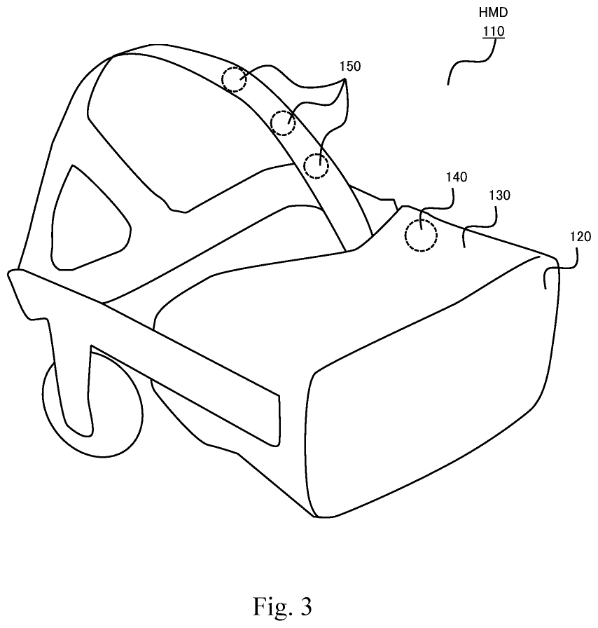

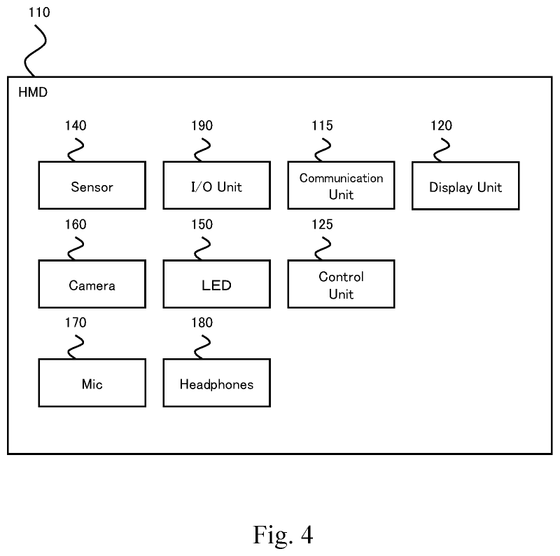

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

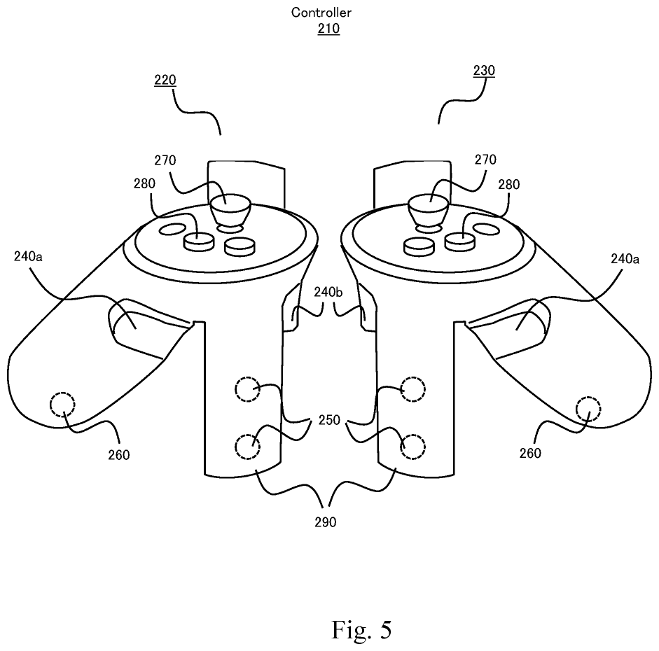

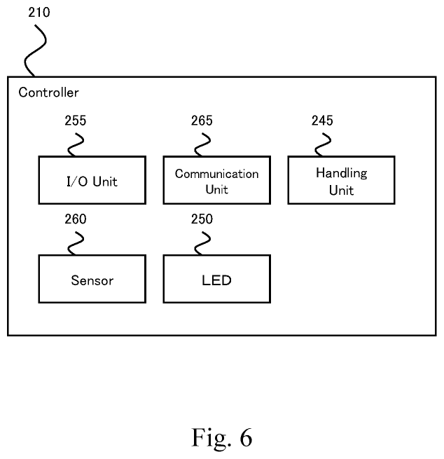

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### Image Generator 310

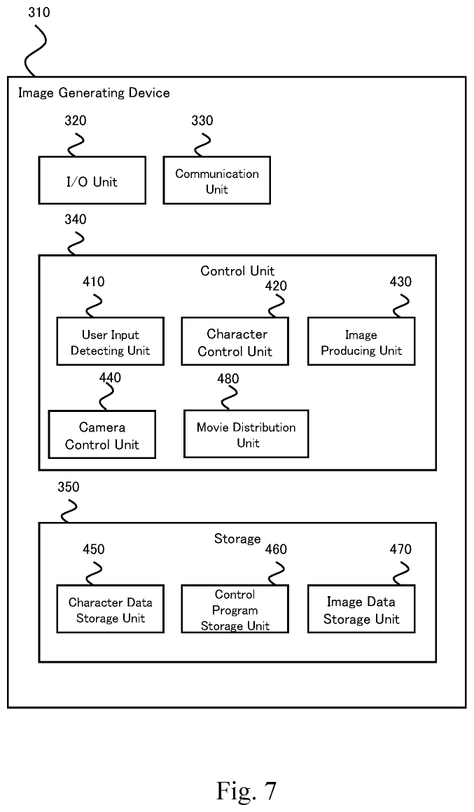

FIG. 7 is a diagram illustrating a functional configuration of an image producing device 310 according to the present embodiment. The image producing device 310 may use a device such as a PC, a game machine, or a portable communication terminal, which has a function for storing information on the movement of the user's head or the movement or operation of the controller acquired by the user input information or the sensor, which is transmitted from the HMD 110 or the controller 210, performing a predetermined computing process, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). Information received from the HMD 110 and/or the controller 210 through the I/O unit 320 and/or the communication unit 330 regarding the movement of the user's head or the movement or operation of the controller 210 is detected in the control unit 340 as input content including the operation of the user's position, line of sight, attitude, etc., speech, operation, etc., and a control program stored in the storage unit 350 is executed according to the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head, the user's speech, and the movement or operation of the controller; a character control unit 420 that executes a control program stored in the control program storage unit 460 for a character 4 stored in the character data storage unit 450 of the storage unit 350; a camera control unit 440 that controls a virtual camera 3 disposed in the virtual space 1 in accordance with the character control; and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4. The image producing unit 430 registers the action data representing the movement of the character 4 controlled by the character control unit 420 and the movement (operation) of the camera 3 controlled by the camera control unit 440 in the image data storage unit 470, and generates an image in which the movement of the character 4 is virtually captured by the camera 3. The control unit 340 also includes a movie distribution unit 480 for distributing the movie image generated by the image producing unit 430. The movie distributing unit 480 may, for example, distribute a moving image by a streaming method or may transmit a file of a moving image.

The storage unit 350 stores in the aforementioned character data storage unit 450 information related to the character 4, such as the attribute of the character 4, as well as the image data of the character 4. A texture image attached to the surface of the character 4 is also stored in the character data storage unit 450. The character data storage unit 450 may also store deformation data for deforming the skeleton of the character 4. The character data storage unit 450 may also store several versions of model data corresponding to the same character. For example, the same character can store model data for different skin and bone races. The character data storage unit 450 may also store model data for various objects (e.g., desks, chairs, cups, beverages, etc.) disposed in the virtual space 1 in addition to the character 4. The control program storage unit 460 controls the operation and expression of the character 4 in the virtual space and stores a program for controlling an object such as the camera 3. The image data storage unit 470 stores the image generated by the image producing unit 430. In this embodiment, the image stored in the image data storage unit 470 can be an action data for generating a moving image. The action data may include, for example, 3D data for displaying the character 4 in the virtual space 1, pause data for identifying the bone structure of the 3D data, motion data for identifying the movement of the bone structure, and the like. In addition, the image producing unit 430 may create (render) a moving image based on the action data and register the video data as a result of rendering in the image data storage unit 470.

The image producing unit 430 can distribute the movie data stored in the image data storage unit 470. The image producing unit 430 can also perform rendering based on the action data stored in the image data storing unit 470 and distribute the rendered video data. In the video distribution system of the present embodiment, the action data can be created and movies can be rendered and transmitted from the action data at least once a day.

The image producing unit 430 can create a movie based on the image captured by the camera 3 while playing the action data stored in the image data storing unit 470, and the movie distributing unit 480 can distribute the movie. In addition, the camera work of the camera 3 may be recorded as the action data, and while playing the camera work of the camera 3, the performance of the character 4 may be performed, and the movie data recorded thereon may be distributed by the video distribution unit 480.

### Send Movie

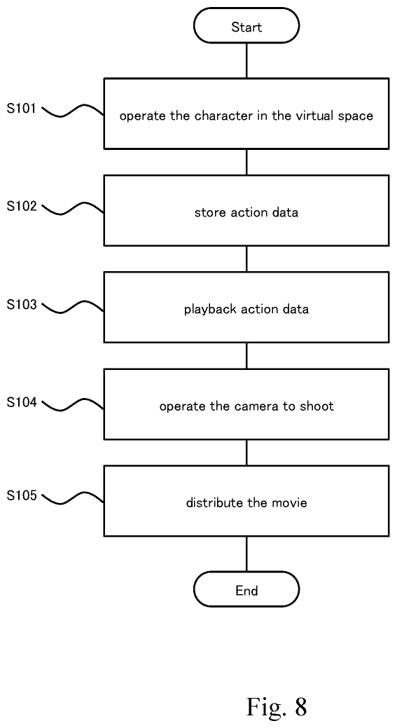

FIG. 8 is a diagram illustrating a flow of a movie distribution process according to a movie distribution system according to the present embodiment. The user can operate the character 4 in the virtual space 1 by operating the HMD 110 or the controller 210 (S101) and store the operation of the character 4 as action data (S102). Then, while the character 4 is operated on the basis of the action data, the recording is performed by operating the camera 3 (S103), and the movie data shot by the camera 3 can be distributed (S104).

As described above, according to the movie distribution system 300 of the present embodiment, a user can operate the camera 3 as the camera man 2 in the virtual space 1 to take video images. Accordingly, since the camera 3 can be operated in the same way as in the real world to take photographs, it is possible to realize a natural camera work and to provide a richer representation of the animated video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space
2 cameraman
3 cameras
4 characters
6 control panel
7 Screens
31 Grid
32 split line
61 display
71 display
72 playback button
110 HMD
120 display panel
130 housing
140 sensor
150 light source
210 controller
220 left hand controller
230 right hand controller
235 grip
240 trigger button
250 Infrared LED
260 sensor
270 joystick
280 menu button
300 Animation Production System
310 Image Generator
320 I/O portion
330 communication section
340 controller
350 storage
410 User Input Detector
420 character control unit
430 Image Generator
440 Camera Control
450 character data storage section
460 Control Program Storage
470 Image Data Storage
480 Replacement Information Storage

1. A method for distributing video, the method comprising:
placing a character in a virtual space;
detecting an input of a user from at least one of a head mounted display and a controller which the user mounted;
controlling an action of the character in response to the input;
controlling a virtual camera placed in the virtual space in response to the input; and
distributing movie data shot by the camera.

2. The method for distributing video according to claim 1, the method further comprising
at least once a day, placing the character, detecting the input, controlling the action of the character in response to the input, controlling the camera in response to the input, and distributing the movie data.

3. The method for distributing video according to claim 1, the method further comprising
recording action data representing the action of the character controlled in response to the input; and
distributing the movie data captured by controlling the camera while playing the action of the character based on the action data.
